(19) United States
(12) Patent Application Publication
(10) Pub. No.: US 2005/0011407 A1
(43) Pub. Date: Jan. 20, 2005

(54) Synthetic asphalt recycled tire rubber emulsions and processes for making them

(76) Inventor: John Eric Partanen, Bakersfield, CA (US)

Correspondence Address: James M. Duncan;Klein, DeNatale, Goldner, Cooper,, Rosenlieb & Kimball, LLP, P.O. Box 11172, Bakersfield, CA, 93389-1172, US

(21) Appl. No.: 10/799,382

(22) Filed: Mar. 12, 2004

Related U.S. Application Data
(60) Provisional application No. 60/486,963, filed on Jul. 14, 2003.

(51) Int. Cl. C09D 4/00; C08K 3/20

(52) U.S. Cl. 106/277; 524/60

(57) ABSTRACT

Synthetic asphalt and petroleum asphalt modified synthetic asphalt emulsions which contain recycled tire rubber and processes for making the emulsions at temperatures above ambient or room temperature. These emulsions may contain significant quantities of recycled tire rubber and recycled and reclaimed motor oils and fluxes. In addition, aluminum chloride and ferric chloride may be used in clay-in-water solutions to form emulsifying agents for the synthetic asphalt and modified synthetic asphalt mixtures.

### CROSS-REFERENCE TO RELATED APPLICATION

U.S. Provisional Application No. 60/486,963 was filed for this invention on Jul. 14, 2003 for which the inventor claims domestic priority.

### BACKGROUND OF THE INVENTION

This invention relates to improved synthetic asphalt emulsions and to processes for making these improved emulsions. These improved emulsions are mixtures of ingredients comprising Gilsonite, man-made asphaltene residiums, tall oil products including tall oil and tall oil pitch, petroleum asphalt, petroleun base lube oils and lube oil extracts, reclaimed and recycled motor oil fluxes, water, surfactants, clays and clay-like materials, chemicals, mineral aggregates, and reclaimed or recycled tire rubber.

The inventor herein has had in effect U.S. Pat. No. 4,437,896 issued Mar. 20, 1984 (the '896 patent). In the patent referenced are formulations and processes for making various synthetic asphalt compositions including synthetic asphalt emulsions. The present invention comprises improvements to synthetic asphalt emulsions and processes for making the same.

Petroleum asphalt is typically made of petroleum products, and includes two components: (1) asphaltenes, or petroleum resins, and (2) maltenes, or heavy oils. The asphaltenes are generally dispersed and melted in the maltenes or heavy oils. There are two primary factors in the manufacture of petroleum asphalts which generally determine the grade of the asphalts. They are the proportion of asphaltenes to the maltenes and the viscosity of the maltenes.

The cost of petroleum asphalt, and petroleum base asphalt recycling agents, has risen sharply in the past few years. Current costs cause the repair of existing asphalt roadways and the construction of new asphalt roadways to be relatively expensive. It is likely that such costs will continue to rise. The availability of man-made, or synthetic, asphalt mixtures, and synthetic asphalt recycling agents, which may be produced and marketed at lower costs per ton than equivalent petroleum base products, help relieve some of the prohibitive costs of the petroleum asphalt.

Emulsions of synthetic asphalt mixtures may incorporate recycled tire rubber products and residue into products which may be used to construct, repair, and maintain city streets, county roads, and state and Interstate highways. In addition, some of these products may be formulated to be used as roofing materials and coatings for industrial and commercial buildings. The processes described herein include the production of synthetic asphalt emulsions containing recycled tire rubber at above ambient temperatures.

### SUMMARY OF THE INVENTION

The following four examples disclose synthetic asphalt, and petroleum asphalt modified synthetic asphalt emulsions that contain recycled tire rubber. Also disclosed are processes for making the emulsions at temperatures above ambient or room temperature. While, depending upon the application, some of these formulations may provide superior results to other formulations, all meet current specifications for products used to make slurry seal asphalt pavement coatings, ASTM D 1227 emulsified asphalt roof coatings, and may have applications as crackfillers for asphalt and portland cement pavements, and as parking lot seal-coat materials. Of particular interest is the use of significant quantities of recycled tire rubber and recycled and reclaimed motor oils and fluxes in these formulas and processes, and the use of Aluminum chloride and Ferric chloride in the clay-in-water solutions to form emulsifying agents for the synthetic asphalt and modified synthetic asphalt mixtures.

### DETAILED DESCRIPTION OF THE INVENTION AND PROCESSES

A. Emulsified Synthetic Asphalt-Tire Rubber Emulsions

### EXAMPLE 1

A synthetic asphalt modified with recycled and granulated tire rubber and petroleum base lube oil extract was prepared at a temperature of 500 degrees Fahrenheit and allowed to cool to 400 degrees Fahrenheit. The actual composition of this material was 62% by weight tall oil pitch, 15% gilsonite, 20% minus 20 mesh recycled tire rubber, and 3% petroleum base lube oil extract. While the synthetic asphalt-tire rubber mixture was cooling to 400 degrees Fahrenheit, a mixture comprising 53.62% kaolinite clay in 46.38% water at room temperature was prepared using moderate to light low shear agitation.

The 400 degree Fahrenheit synthetic asphalt-tire rubber mixture was slowly added to the clay and water mixture while the light to moderate low shear agitation was continued. The 400 degree Fahrenheit synthetic asphalt-tire rubber mixture was easily emulsified by the clay and water solution until the temperature of the emulsion began to get near to 200 degrees Fahrenheit, very near to the boiling point of the water. Additional water was added to the emulsion to keep the emulsion from boiling and being ruined, until the desired amount of the synthetic asphalt-tire rubber mixture had been added and emulsified. The temperatures at which the emulsion was made varied between 130 degrees Fahrenheit and 200 degrees Fahrenheit. Additional water was then added and mixed in to adjust the solids or residue content of the emulsion to about 52%, to adjust the final viscosity of the emulsion to 10,000 cps or less, and to cool the emulsion to about 150 degrees Fahrenheit.

The resulting emulsion comprised 47.9% by weight water, 33.6% by weight synthetic asphalt-tire rubber, and 18.5% by weight kaolinite clay. The residue by evaporation of this emulsion was 52.7% by weight, and the actual viscosity of the emulsion after it had been allowed to cool to room temperature was 9800 centipoise. This improved synthetic asphalt-tire rubber emulsion was tested as a cold applied asphalt-rubber crack-filler for asphalt pavements and found to be highly satisfactory. This improved synthetic asphalt-tire rubber emulsion could also be used as an ASTM D 1227 Type II roof coating.

### EXAMPLE 2

A synthetic asphalt modified with petroleum asphalt, recycled motor oil flux, and recycled and granulated tire rubber was prepared at a temperature 500 degrees Fahrenheit and allowed to cool to 325 degrees Fahrenheit. The actual composition of this material was 65.0% by weight of PG (Performance Grade) 64-22 petroleum asphalt, 7.5% by weight tall oil pitch, 8.0% by weight gilsonite, 9.5% by weight recycled motor oil flux, and 10% by weight minus 30 mesh recycled tire rubber. While the synthetic asphalt-tire rubber mixture was cooling a solution comprising 92.10% by weight cold water, 0.47% by weight sodium chromate, 3.48% by weight nonylphenol surfactant, and 3.95% by weight bentonite clay was prepared. This solution was prepared with moderate to low shear agitation and mixed until uniform. The pH of the solution was checked and found to be 6.5.

This solution was then transferred to another container into which a Silverson Duplex Ultra High Shear Mixer was inserted. The mixer was turned on to 6500 rpm and the synthetic asphalt-tire rubber mixture, at temperatures of 325 to 275 degrees, was slowly introduced until the desired amount had been added. The synthetic-tire rubber mixture was readily emulsified. The synthetic asphalt-tire rubber emulsion was subjected to additional ultra high shear at 8500 to 9000 rpm until a stable emulsion at about 160 degrees to 190 degrees Fahrenheit was achieved. To the emulsion was then added an additional 2.25% minus 30 mesh tire rubber, using the ultra high shear mixer to achieve uniform dispersion and 2.05% cationic latex rubber while the ultra high shear mixing continued.

This emulsion was then allowed to cool to room temperature and tested. The residue by evaporation of the emulsion was found to be 50.25% by weight. The viscosity of the emulsion was found to be 3800 cps. The actual composition of this emulsion was: 49.00% by weight water, 0.25% by weight sodium chromate, 1.85% by weight nonylphenol surfactant, 2.10% by weight bentonite clay, 2.05% by weight cationic latex, 27.63% by weight PG 64-22 petroleum asphalt, 3.19% by weight tall oil pitch, 3.40% by weight gilsonite, 4.03% by weight recycled motor oil flux, and 6.5% by weight minus 30 mesh recycled tire rubber.

This improved synthetic asphalt-tire rubber emulsion was found to be satisfactory in the preparation of slurry seal asphalt pavement coatings. The actual slurry seal asphalt pavement coating was prepared by combining it with 55 to 60% by weight slurry seal mineral aggregates to which 0to 8% by weight water is added, and to which 37 to 40% by weight of the improved synthetic asphalt-tire rubber is added, mixed and spread out onto the surface of asphalt pavements.

This improved synthetic asphalt-tire rubber emulsion also meets or exceeds the specifications for ASTM D 1227 Type III roof coating. This improved synthetic asphalt-tire rubber emulsion also performs well as a tire rubber modified, cold applied crack-filler for asphalt and portland cement streets, roads, and highways. An additional unique characteristic of this synthetic asphalt tire rubber emulsion is the incorporation of used and reclaimed motor oil flux.

### EXAMPLE 3

A synthetic asphalt modified with petroleum asphalt was prepared at temperatures of 325 to 350 degrees Fahrenheit with moderate to high shear agitation. This synthetic asphalt mixture was comprised of 86.9% by weight PG 64-22 petroleum asphalt, 6.67% by weight gilsonite, and 6.43% by weight tall oil pitch. A bentonite clay solution comprised of 90.05% by weight water, 0.38% by weight aluminum chloride, 4.84% by weight bentonite clay and 4.73% by weight nonylphenol surfactant was prepared using a Silverson Duplex ultra high shear mixer at 74 degrees Fahrenheit with a pH of 6.2.

The modified synthetic asphalt was slowly added at temperatures of 275 to 325 degrees Fahrenheit to the bentonite clay solution with the mixer turning at 6500 rpm until the mixture formed an emulsion. With the mixer still turning at 6500 rpm, minus 30 mesh recycled tire rubber was added, followed by the addition of cationic acrylic latex, and the resulting improved synthetic asphalt tire rubber emulsion was mixed until a stable mineral colloidal emulsion was formed. The temperature at which the final emulsion was made was 160 to 190 degrees Fahrenheit.

The final emulsion was comprised of 47.60% by weight water, 0.20% by weight aluminum chloride, 2.56% by weight bentonite clay, 2.50% by weight nonlyphenol surfactant, 39.47% by weight synthetic asphalt modified with petroleum asphalt, 6.67% by weight minus 30 mesh granulated recycled tire rubber, and 1.00% by weight cationic acrylic latex. The residue by evaporation of this new, improved and unique emulsion was 48.1% by weight. The viscosity of the new improved emulsion was found to be between 750 and 22,000 centipoise.

In the example above, a unique feature is the use of aluminum chloride which in the solution yields both positive aluminum ions and negative chloride ions. The aluminum ions attach to the clay particles and render them capable of emulsifying the modified synthetic asphalt base. The chloride ions lower the pH of the clay-in-water solution to below 6.5, which is required to make a stable mineral colloidal emulsion. Chemists skilled in the art of making bentonite clay mineral colloidal emulsions usually use chromium ions with clays to render them as emulsifying agents. In recent years however, the use of chromium has been found to be harmful, toxic, and hazardous. Aluminum reacts chemically in many similar ways to chromium, but does not share the unhealthy and harmful effects of chromium. The improved, new, and unique modified synthetic asphalt recycled tire rubber emulsion may be used as a crack-filler for asphalt and portland cement pavements, as an ASTM D 1227 Type III roof coating, and in the preparation of slurry seal and seal coat asphalt pavement coatings as described above in Example 2.

### EXAMPLE 4

A synthetic asphalt modified with petroleum asphalt was prepared and emulsified as in example 3 above. A bentonite clay solution comprised of 91.63% by weight water, 0.39% by weight ferric chloride, 5.84% by weight bentonite clay and 1.95% by weight nonylphenol surfactant, and 0.19% by weight citric acid was prepared using a Silverson Duplex ultra high shear mixer at 74 degrees Fahrenheit with a pH of 4.5.

The synthetic asphalt modified with petroleum asphalt was added at temperatures of 275 to 325 degrees Fahrenheit to the bentonite clay solution with the mixer turning at 6500 rpm until the desired quantity had been added. With the mixer still turning at 6500 rpm, minus 30 mesh recycled tire rubber and cationic styrene butadiene latex rubber was added and mixed until uniform to complete the emulsion. The temperature at which the final emulsion was made was 160 to 190 degrees Fahrenheit.

The final emulsion was comprised of 47.1% by weight water, 0.20% by weight ferric chloride, 3.0% by weight bentonite clay, 1.0% by weight nonlyphenol surfactant, 0.1% by weight citric acid, 40.0% by weight synthetic asphalt modified with petroleum asphalt, 6.60% by weight minus 30 mesh granulated recycled tire rubber, and 2.00% by weight cationic styrene butadiene latex rubber. The residue by evaporation of this new, improved and unique emulsion was 51.0% by weight. The viscosity of the new improved emulsion was 800 cps.

In the example above, a unique feature is the replacement of chromium ions with ferric ions in the preparation of the bentonite clay solution. Chromium ions from chromic acid and the sodium and potassium salts of chromium interact with the bentonite clay in water solutions, rendering these solutions capable of emulsifying bituminous products. Bentonite clay asphalt emulsions have been prepared in this manner for many years, and indeed there are ASTM standards and specifications for these roof coating emulsions. In more recent years, the use of chromium in these emulsions and other products has been found to be harmful, toxic, and hazardous. Ferric ions react chemically in some similar ways to chromium ions, but ferric ions do not share the unhealthy and harmful effects of exposure to chromium ions. The improved, new, and unique modified synthetic asphalt recycled tire rubber emulsion may be used as an ASTM D 1227 Type III roof coating, as a crack-filler for asphalt and portland cement pavements, and in the preparation of slurry seal and seal coat asphalt pavement coatings as described in the examples above.

B. Processes for Making the Improved Emulsified Synthetic Tire Rubber Emulsions

In example 1 above, the improved emulsified synthetic tire rubber emulsion is made with low to moderate agitation and shear. The preferred equipment for production of the example 1 product is a cylindrical, or semi-cylindrical horizontal tank equipped with a central shaft with paddles, and or helical ribbons. These tanks are commonly referred to as paddle mixers and ribbon blenders. There are vertical cylindrical tanks that may also be used that may be equipped with paddles, helical ribbons, or combinations of both, and that may also have more than one shaft.

The first step in making the example 1 improved synthetic tire rubber emulsion is to prepare a clay slurry comprised of 50% to 55% by weight of kaolinite clay in 50% to 45% by weight water. This clay slurry may be made at temperatures of between 40 to 100 degrees Fahrenheit, and must be stirred until the clay is well dispersed or lump free. Synthetic asphalt mixture, 30% to 40% by weight of the final product to be made, at temperatures of between 275 to 400 degrees Fahrenheit, is then added slowly to the clay slurry while the agitator, or agitators are turning. Mixing continues until the required amount of synthetic asphalt-tire rubber is added. During the addition of the synthetic asphalt-tire rubber more water at temperatures of 40 to 100 degrees Fahrenheit is added to prevent the mixture from boiling, and to keep the viscosity low enough for the mixers to be effective. After all of the synthetic asphalt-tire rubber has been added, the emulsion is mixed for a period of between 15 to 60 minutes to completely emulsify the synthetic asphalt-tire rubber. Additional water may then be added to adjust the residue content of the final improved, and new emulsion to a residue content of 48 to 55% by weight, with a final viscosity of 2500 to 20,000 centipoises. The final emulsion obtained typically has a temperature of between 130 degrees to 160 degrees Fahrenheit.

Moderate to high shear mixers such as batch type vertical, bottom entry, or side entry high shear mixers may also be used. With these types of mixers the initial kaolinite clay slurry is usually 15 to 29% by weight in water. Chemicals such as sodium metasilicates, sodium silicates, acetic acid, citric acid, hydrochloric acid, chromic acid, chromate salts of sodium or potassium, and aluminum chloride or ferric chloride, (collectively, pH adjusting substances) may be added to adjust the pH of the clay slurry and impart the desired ability to emulsify the synthetic asphalt mixtures. The desired quantity of synthetic asphalt-tire rubber is then slowly added while the high shear mixers are turning. Mixing continues until the synthetic asphalt-tire rubber has been emulsified. Near the end of the mixing process, additional water may be added to adjust the residue content and viscosity of the end product. Temperatures of the final emulsions are typically between 130 and 160 degrees Fahrenheit with these processes.

Continuous high shear mixers, commonly known as colloid mills may also be used but only if there is a capability to recirculate the entire batch of emulsion to be made through the colloid mill until the synthetic asphalt-tire rubber has been completely emulsified and adjusted to its desired residue content and viscosity. Temperature of the final emulsions are typically 140 to 210 degrees Fahrenheit with these processes.

In examples 2, 3, and 4 above, the synthetic asphalt-tire rubber mixture is emulsified with a vertically suspended ultra high shear mixer equipped with a high speed chopper within a shrouded zone above the rotor-stator emulsifier head. As the ultra high shear mixer turns at high speed, a strong vortex is generated which draws the synthetic asphalt-tire rubber into the shrouded zone where it is chopped into small enough pieces to be emulsified by the rotor-stator emulsifier. There are two manufacturers of these types of ultra high shear mixers. One is made by the Charles Ross and Son Company and is known as the Ross Mixer Dissolver. The other is made by Silverson Machines, Inc and is known as the Duplex Disintegrator/Dissolver.

Temperatures of the final emulsions are typically 140 to 210 degrees Fahrenheit with this process.

Continuous high shear colloid mills equipped with multiple inline rotor-stators such as the Greerco Corp.Tandem Shear Pipeline Mixer, The Greerco Corp. Tandem Refiner, and the Ika Works Inc. Dispax-Reactor may also be used to produce the new, improved and unique emulsions. Single stage, or colloid mills equipped with a single rotor and stator may be used with recirculation until a stable emulsion is produced, or two or more single stage colloid mills in line may be used to produce a stable mineral colloid emulsion. Temperatures of the final emulsions are typically between 140 to 210 degrees Fahrenheit with these processes.

The emulsions described above may include other additives. For example, co-emulsifiers may be added to the clay slurry to assist the formation of the emulsion. Acceptable co-emulsifiers are nonylphenol surfactants and quaternary ammonium chloride. As is known in the art, various performance enhancing additives may be added to the synthetic asphalt-tire rubber emulsions. Such performance enhancing additives may comprise petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber and natural fiber. In addition, end use modifying additives may be added to the emulsion. The end use modifying additives may be selected depending upon the particular use of the emulsion. The end use modifying additives may comprise crushed and sieve sized mineral aggregates, crushed and sieve sized recycled asphalt pavement, crushed and sieve sized portland cement concrete, and sand

1. A method of preparing a synthetic asphalt recycled tire rubber emulsion which may be used as a crack-filler for asphalt and portland cement pavements, as a roof coating, slurry seal coating, or as a seal coat for asphalt pavements, the method comprising:
preparing a first mixture of a synthetic asphalt-recycled tire rubber base by mixing together gilsonite in a tall oil product with granulated recycled tire rubber at temperatures of 375 to 500 degrees Fahrenheit and allowing the first mixture to cool to 275 to 400 degrees;
preparing a second mixture comprising water and clay at a temperature of 40 to 140 degrees; and
slowly adding the first mixture with the second mixture to form the emulsion at 100 to 210 degrees.

2. The method of claim 1 wherein the tall oil product comprises crude tall oil.

3. The method of claim 1 wherein the tall oil product comprises tall oil.

4. The method of claim 1 wherein the tall oil product comprises tall oil pitch.

5. The method of claim 1 wherein the tall oil product comprises a mixture of crude tall oil, tall oil and tall oil pitch.

6. The method of claim 1 wherein the clay comprises kaolinite.

7. The method of claim 1 wherein the clay comprises bentonite.

8. The method of claim 1 wherein the clay comprises magnesium silicate.

9. The method of claim 1 wherein the clay comprises a blend of kaolinite, bentonite and magnesium silicate.

10. The method of claim 1 wherein the first mixture further comprises a performance enhancing additive.

11. The method of claim 10 wherein the performance enhancing additive is selected from the group consisting of petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber and natural fiber.

12. The method of claim 10 wherein the performance enhancing additive is selected from any one or more of the group comprising petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber, and natural fiber.

13. The method of claim 1 wherein the second mixture further comprises a pH adjusting substance.

14. The method of claim 13 wherein the pH adjusting substance is selected from the group consisting of hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

15. The method of claim 13 wherein the pH adjusting substance is selected from any one or more of the group comprising hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

16. The method of claim 1 wherein the second mixture comprises a co-emulsifier.

17. The method of claim 16 wherein the co-emulsifier comprises a nonylphenol surfactant.

18. The method of claim 16 wherein the co-emulsifier comprises quaternary ammonium chloride.

19. The method of claim 1 wherein the emulsion further comprises an end use modifying additive.

20. The method of claim 19 wherein the end use modifying additive is selected from the group consisting of crushed and sieve sized mineral aggregates, crushed and sieve sized recycled asphalt pavement, crushed and sieve sized portland cement concrete, and sand.

21. The method of claim 19 wherein the end use modifying additive is selected from any one or more of the group comprising crushed and sieve sized mineral aggregates, crushed and sieve sized recycled asphalt pavement, crushed and sieve sized portland cement concrete, and sand.

22. The method of claim 1 wherein the granulated recycled tire rubber is minus 16 mesh to minus 80 mesh.

23. Synthetic asphalt produced according to the method of claim 1.

24. A method of preparing a synthetic asphalt recycled tire rubber emulsion which may be used as a crack-filler for asphalt and portland cement pavements, as a roof coating, slurry seal coating, or as a seal coat for asphalt pavements, the method comprising:
preparing a first mixture of a synthetic asphalt-recycled tire rubber base by mixing together manmade asphaltene in a tall oil product with granulated recycled tire rubber at temperatures of 375 to 500 degrees Fahrenheit and allowing the first mixture to cool to 275 to 400 degrees;
preparing a second mixture comprising water and clay at a temperature of 40 to 140 degrees; and
blending the first mixture with the second mixture to form the emulsion at 100 to 210 degrees.

25. The method of claim 24 wherein the tall oil product comprises crude tall oil.

26. The method of claim 24 wherein the tall oil product comprises tall oil.

27. The method of claim 24 wherein the tall oil product comprises tall oil pitch.

28. The method of claim 24 wherein the tall oil product comprises a mixture of crude tall oil, tall oil and tall oil pitch.

29. The method of claim 24 wherein the clay comprises kaolinite.

30. The method of claim 24 wherein the clay comprises bentonite.

31. The method of claim 24 wherein the clay comprises magnesium silicate.

32. The method of claim 24 wherein the clay comprises a blend of kaolinite, bentonite and magnesium silicate.

33. The method of claim 24 wherein the first mixture further comprises a performance enhancing additive.

34. The method of claim 33 wherein the performance enhancing additive is selected from the group consisting of petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber, and natural fiber.

35. The method of claim 33 wherein the performance enhancing additive is selected from any one or more of the group comprising petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber, and natural fiber.

36. The method of claim 24 wherein the second mixture further comprises a pH adjusting substance.

37. The method of claim 36 wherein the pH adjusting substance is selected from the group consisting of hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

38. The method of claim 36 wherein the pH adjusting substance is selected from any one or more of the group comprising hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

39. The method of claim 24 wherein the second mixture comprises a co-emulsifier.

40. The method of claim 39 wherein the co-emulsifier comprises a nonylphenol surfactant.

41. The method of claim 39 wherein the co-emulsifier comprises quaternary ammonium chloride.

42. The method of claim 24 wherein the emulsion further comprises an end use modifying additive.

43. The method of claim 42 wherein the end use modifying additive is selected from the group consisting of crushed and sieve sized mineral aggregates, crushed and sieve sized recycled asphalt pavement, crushed and sieve sized portland cement concrete, and sand.

44. The method of claim 42 wherein the end use modifying additive is selected from any one or more of the group comprising crushed and sieve sized mineral aggregates, crushed and sieve sized recycled asphalt pavement, crushed and sieve sized portland cement concrete, and sand.

45. The method of claim 24 wherein the granulated recycled tire rubber is minus 16 mesh to minus 80 mesh.

46. Synthetic asphalt produced according to the method of claim 24.

47. A composition of a synthetic asphalt recycled tire rubber emulsion which may be used as a crack-filler for asphalt and portland cement pavements, as a roof coating, slurry seal coating, or as a seal coat for asphalt pavements, the composition comprising:
a first mixture of a synthetic asphalt-recycled tire rubber base comprising 15% by weight gilsonite, 62% by weight tall oil product and 20% by weight granulated recycled tire rubber and 3% by weight petroleum base lube oil, the first mixture blended with a second mixture, the second mixture comprising 46.38% by weight water and 53.62% by weight clay, wherein the blended first mixture and second mixture results in an emulsion comprising 47.9% by weight water, 33.6% by weight synthetic asphalt-tire rubber and 18.5% clay.

48. A composition of a synthetic asphalt recycled tire rubber emulsion which may be used as a crack-filler for asphalt and portland cement pavements, as a roof coating, slurry seal coating, or as a seal coat for asphalt pavements, the composition comprising:
a first mixture of a petroleum asphalt/synthetic asphalt-recycled tire rubber base comprising 65% by weight of PG 64-22 petroleum asphalt, 8% by weight gilsonite, 7.5% by weight tall oil pitch, 9.5% by weight recycled motor oil flux, and 10% by weight minus 30 mesh recycled tire rubber, the first mixture blended with a second mixture, the second mixture comprising 92.10% by weight water, 0.47% by weight sodium chromate, 3.48% by weight nonylphenol surfactant and 3.95% by weight bentonite clay, wherein an additional 2.25% minus 30 mesh tire rubber and 2.05% cationic latex rubber is added to the blended first mixture and second mixture, resulting in an emulsion comprising 49.00% by weight water, 0.25% by weight sodium chromate, 1.85% by weight nonylphenol surfactant, 2.10% by weight bentonite clay, 2.05% by weight cationic latex, 27.63% PG 64-22 petroleum asphalt, 3.19% by weight tall oil pitch, 3.40% by weight gilsonite, 4.03% by weight recycled motor oil flux, and 6.5% by weight minus 30 mesh recycled tire rubber.

49. A composition of a synthetic asphalt recycled tire rubber emulsion which may be used as a crack-filler for asphalt and portland cement pavements, as a roof coating, slurry seal coating, or as a seal coat for asphalt pavements, the composition comprising:
a first mixture of a petroleum asphalt/synthetic asphalt-recycled tire rubber base comprising 86.9% by weight of PG 64-22 petroleum asphalt, 6.67% by weight gilsonite, 6.43% by weight tall oil pitch, the first mixture blended with a second mixture, the second mixture comprising 90.05% by weight water, 0.38% by weight aluminum chloride, 4.73% by weight nonylphenol surfactant and 4.84% by weight bentonite clay, wherein additional minus 30 mesh tire rubber and cationic latex rubber are added to the blended first mixture and second mixture to form a stable mineral colloidal emulsion comprising 47.60% by weight water, 0.20% by weight aluminum chloride, 2.50% by weight nonylphenol surfactant, 2.56% by weight bentonite clay, 1.00% by weight cationic latex, 39.47% by weight synthetic asphalt modified with petroleum asphalt, and 6.67% by weight minus 30 mesh recycled tire rubber.

50. A composition of a synthetic asphalt recycled tire rubber emulsion which may be used as a crack-filler for asphalt and portland cement pavements, as a roof coating, slurry seal coating, or as a seal coat for asphalt pavements, the composition comprising:
a first mixture of a petroleum asphalt/synthetic asphalt-recycled tire rubber base comprising 86.9% by weight of PG 64-22 petroleum asphalt, 6.67% by weight gilsonite, 6.43% by weight tall oil pitch, the first mixture blended with a second mixture, the second mixture comprising 91.63% by weight water, 0.39% by weight ferric chloride, 1.95% by weight nonylphenol surfactant, 5.84% by weight bentonite clay, and 0.19% by weight citric acid, wherein additional minus 30 mesh tire rubber and cationic styrene butadiene latex rubber are added to the blended first mixture and second mixture to form a uniform emulsion comprising 47.1% by weight water, 0.20% by weight ferric chloride, 1.0% by weight nonylphenol surfactant, 3.0% by weight bentonite clay, 0.1% by weight citric acid, 40.0% by weight synthetic asphalt modified with petroleum asphalt, 6.60% by weight minus 30 mesh recycled tire rubber, and 2.0% by weight cationic butadiene latex rubber.
